(19) United States
(12) Patent Application Publication
(10) Pub. No.: US 2003/0221289 A1
(43) Pub. Date: Dec. 4, 2003

(54) WASHER FOR A PIVOT HINGE

(76) Inventor: Sheng-Nan Lu, Taipei Hsien (TW)

Correspondence Address: Rabin & Berdo, P.C., Suite 500, 1101 14th Street, Washington, DC, 20005, US

(21) Appl. No.: 10/157,244

(22) Filed: May 30, 2002

(51) Int. Cl. E05D 11/08; E05C 17/64

(52) U.S. Cl. 16/340

(57) ABSTRACT

A pivot hinge has a stem, a bracket and washers provided on opposite sides of the bracket. Each washer is a disk and composed of multiple first sectorial areas and multiple sectorial areas parallel to the first sectorial areas. Each of the first sectorial areas is intermittently connected to one another and a second sectorial area is formed between two adjacent first sectorial areas.

### BACKGROUND OF THE INVENTION

1. Field of the Invention

The present invention relates to a washer, and more particularly to washer for a pivot hinge with a pivot stem and a bracket. The washer is substantially a disk and composed of first sectorial areas and second sectorial areas each intermittently connected to one another. The washer is provided to opposite sides of the bracket to engage with the bracket, so that when the stem pivots, the engagement between the second sectorial areas and the bracket provides the required friction.

2. Description of Related Art

With reference to FIGS. 5 and 6, a conventional pivot hinge is composed of a bracket (60) and a stem with a threaded end (61). The bracket (60) has multiple washers (62) provided on opposite sides of the bracket (60), a lubrication disk (63) located outside the washer (62), multiple springs (64) provided outside the lubrication disk (63), a positioning disk (65) and a nut (66).

When the pivot hinge of this kind is to be assembled, the threaded end (61) of the stem extends through the washers (62) on one side of the bracket (60) and the washers (62) on the other side of the bracket (60), the lubrication disk (63), the springs (64), the positioning disk (65) and into the nut (66) to be screwingly connected to the nut (66). It is noted from the structure that when the stem pivots relative to the bracket (60), the friction required comes from the engagement between the bracket (60) and the washers (62). Because the washers (62) are completely in engagement with the bracket (60), the friction therebetween will gradually wear the washers (62), which leads to a short life span of the pivot hinge.

It is appreciated especially from FIG. 2 that the each washer (30) is substantially a disk and composed of multiple first sectorial areas (31) and multiple sectorial areas (32) parallel to the first sectorial areas (31). Each of the first sectorial areas (31) is intermittently connected to one another. That is, a second sectorial area (32) is formed between two adjacent first sectorial areas (31). Furthermore, to increase the lubrication between the washers (30) and the bracket (10), a slit (33) is defined in each of the second sectorial areas (32) so that the user is able to add in lubrication to lubricate the contact between the washers (30) and the bracket (10).

With reference to FIGS. 3 and 4, after the assembly of the pivot hinge of the present invention via the nut (50) secured to a threaded end (21) of the stem (20), as shown in FIG. 3, or a rivet (not numbered) secured to the threaded end (21), as shown in FIG. 4, only the first sectorial areas (31) engage with the bracket (10). Because friction of the pivot hinge comes from the engagement between the washers (30) and the bracket (10) and there are only the first sectorial areas (31) engaging with the bracket (10), the wear as a result of friction to the washers (30) is low, such that the life span of the washers (30) is prolonged.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

To overcome the shortcomings, the present invention tends to provide an improved washer for a pivot hinge to mitigate and obviate the aforementioned problems.

### SUMMARY OF THE INVENTION

The primary objective of the present invention is to provide an improved washer for a pivot hinge having a stem and a bracket. The washer is a disk composed of first sectorial areas and second sectorial areas parallel to the first sectorial areas, such that with a small area engaged with the bracket, the life span of the pivot hinge is prolonged.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the pivot hinge of the present invention;

FIG. 2 is an exploded perspective view of the pivot hinge shown in FIG. 1;

FIG. 3 is a side plan view of the pivot hinge in assembly;

FIG. 4 is a side plan view of the pivot hinge in assembly of still another preferred embodiment of the present invention;

FIG. 5 is an exploded perspective view of a conventional pivot hinge; and

FIG. 6 is a perspective view of the conventional pivot hinge in FIG. 5.

### DETAILED DESCRIPTION OF THE PREFERRED EMBODIMENT

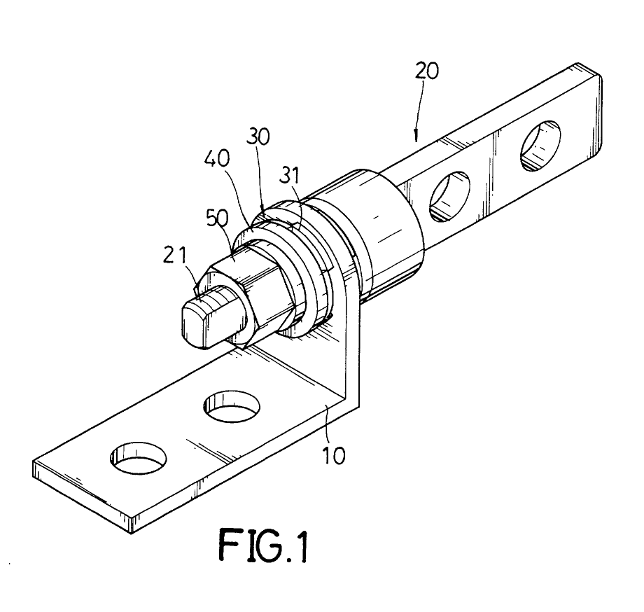

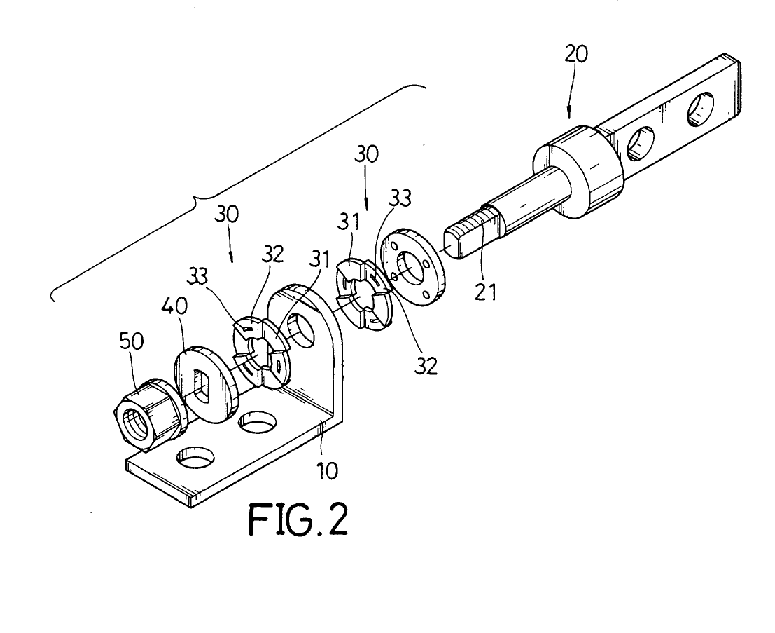

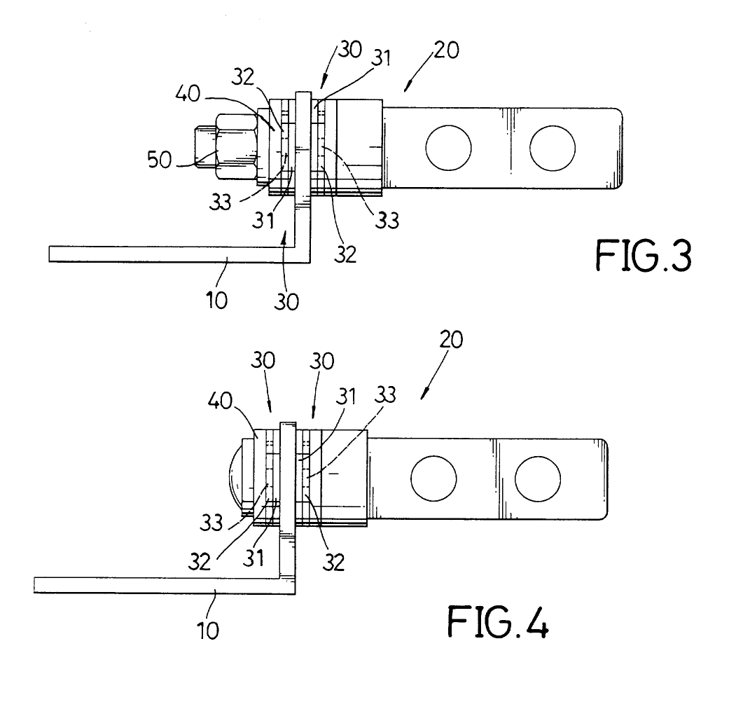

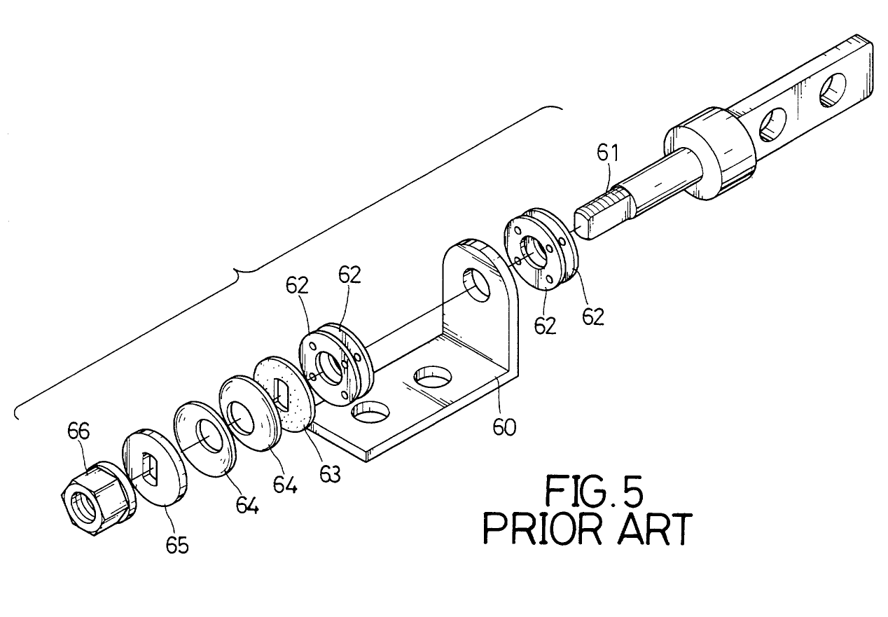

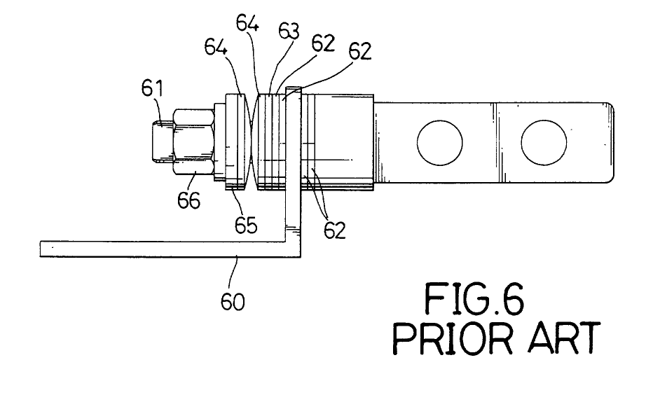

With reference to FIGS. 1 and 2, the pivot hinge in accordance with the present invention is composed of a bracket (10), a stem (20), washers (30), a positioning disk (40) and a nut (50). Because the bracket (10), the stem (20), the positioning disk (40) and the nut (50) are conventional in the art, and are not the focus of the present invention, detailed description thereof is omitted hereinafter.

What is claimed is:

1. In a pivot hinge having a stem, a bracket and washers provided on opposite sides of the bracket, wherein the improvements comprise:
each washer being a disk and composed of multiple first sectorial areas and multiple sectorial areas parallel to the first sectorial areas,
wherein each of the first sectorial areas is intermittently connected to one another and the second sectorial areas are all spaced in a same direction away from the first sectorial areas and the second sectorial areas are respectively formed between the first sectorial areas.

2. The pivot hinge as claimed in claim 1, wherein a slit is defined in each of the second sectorial areas.
